(19) United States
(12) Patent Application Publication
(10) Pub. No.: US 2011/0127462 A1
(43) Pub. Date: Jun. 2, 2011

(54) ELECTRODE COMPOSITION FOR INKJET PRINT, ELECTRODE PREPARED USING THE ELECTRODE COMPOSITION, AND LITHIUM BATTERY COMPRISING THE ELECTRODE

(75) Inventors: Jae-man CHOI, Hwaseong-si (KR); Hansu Kim, Seoul (KR); Moon-seok Kwon, Hwaseong-si (KR); Min-sang Song, Seongnam-si (KR)

(73) Assignee: Samsung Electronics Co., Ltd., Suwon-si (KR)

(21) Appl. No.: 12/853,583

(22) Filed: Aug. 10, 2010

(30) Foreign Application Priority Data
Dec. 2, 2009 (KR) 10-2009-0118455

(51) Int. Cl. H01M 4/485

(52) U.S. Cl. 252/182.1

(57) ABSTRACT

A negative electrode composition for inkjet print including beta phase TiO₂ particles, an aqueous solvent, and a dispersant, a negative electrode prepared by inkjet printing the negative electrode composition, and a lithium battery including the negative electrode.

### CROSS-REFERENCE TO RELATED APPLICATION

This application claims the benefit of Korean Patent Application No. 10-2009-0118455, filed on Dec. 2, 2009, in the Korean Intellectual Property Office, the disclosure of which is incorporated herein by reference.

### BACKGROUND

1. Field

An aspect of the present invention relates to an electrode composition for inkjet print, an electrode prepared using the electrode composition, and a lithium battery including the electrode.

2. Description of the Related Art

Light portable electronic devices having increased high performance use secondary batteries as power sources. Thus, secondary batteries are prepared using characteristics that ensure the safety of portable electronic devices that have various shapes. Secondary batteries used as power sources for hybrid and/or electric automobiles have properties suitable therefor such as high output power and miniaturization and lightweight characteristics. Accordingly, secondary batteries constituting a battery assembly are manufactured as small and lightweight thin films. Secondary batteries used for power sources of flexible displays are thin, light, and flexible. Secondary batteries used for power sources of integrated circuit devices are patterned in a regular form.

Inkjet print is one of the methods of preparing electrodes for secondary batteries having various characteristics. According to inkjet printing, an electrode active material is coated on the surface of a current collector uniformly, evenly, and inexpensively to form a predetermined pattern.

A negative electrode composition used for the inkjet printing includes negative electrode active material particles dispersed in a solvent. The negative electrode active material may be graphite, Li₄Ti₅O₁₂, or the like. As the particle size of graphite is reduced to a nanometer level, irreversible reactions increase. LiₐTi₅O₁₂ has a discharge capacity of equal to or less than 200 mAh/g.

Thus, there is a need for negative electrode active material particles having enhanced lifetime and capacity characteristics.

### SUMMARY

An aspect of the present invention provides a negative electrode composition for inkjet print including a negative electrode active material.

According to another aspect of the present invention, there is provided a negative electrode prepared by inkjet printing the negative electrode composition.

According to another aspect of the present invention, there is provided a lithium battery including a negative electrode.

According to an aspect of the present invention, a negative electrode composition for inkjet print includes beta phase TiO₂ particles, an aqueous solvent, and a dispersant.

According to another aspect of the present invention, a negative electrode is prepared by inkjet printing the negative electrode composition.

According to another aspect of the present invention, a lithium battery includes the negative electrode.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a graph illustrating charge/discharge efficiency of a lithium battery prepared according to Example 1 at a 1^{st} cycle.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, a negative electrode composition for inkjet print according to an embodiment of the present invention will be described in more detail.

A negative electrode composition for inkjet print according to an embodiment of the present invention includes beta phase TiO₂ particles, an aqueous solvent, and a dispersant. The negative electrode composition may provide high discharge capacity of equal to or greater than 200 mAh/g and have excellent lifetime characteristics due to beta phase TiO₂. The beta phase TiO₂ may have a monoclinic crystal system. In the monoclinic crystal system, the beta phase TiO₂ may have a β angle of 107.054°. The beta phase TiO₂ may have a density of 3.73 g/cm³. The beta phase TiO₂ particles is a negative electrode active material.

The beta phase TiO₂ particles may have an average particle diameter of less than 1 μm. For example, the average particle diameter of the beta phase TiO₂ particles may be in the range of about 50 to about 450 nm. For example, the average particle diameter of the beta phase TiO₂ particles may be in the range of about 50 to about 350 nm. For example, the average particle diameter of the beta phase TiO₂ particles may be in the range of about 50 to about 150 nm. When the beta phase TiO₂ particles has the average particle diameter within the range described above, the particles have high dispersibility, and a negative electrode composition including the beta phase TiO₂ particles may be smoothly ejected via a nozzle. If the average particle diameter of the beta phase TiO₂ particles is greater than 1 μm, dispersibility of the particles may be insufficient for inkjet printing. In addition, the negative electrode may not be formed in a thin film.

The amount of the beta phase TiO₂ particles may be in the range of about 1 to about 10 wt % based on the total weight of the negative electrode composition, but is not limited thereto. The amount may vary according to those of ordinary skill in the art. For example, the amount of the beta phase TiO₂ particles may be in the range of about 3 to about 7 wt % based on the total weight of the negative electrode composition. If the amount of the beta phase TiO₂ is too low, inkjet printing efficiency may be reduced. If the amount of the beta phase TiO₂ is too high, dispersibility and jettability of the beta phase TiO₂ particles may be reduced.

The negative electrode composition may further include another negative electrode active material in addition to the beta phase TiO₂ particles. For example, the additional negative electrode active material may be carbon, metal compound, metal oxide, lithium oxide, lithium-metal oxide, boron-added carbon, or any mixture thereof.

In particular, the additional negative electrode active material may be natural graphite, artificial graphite, graphite carbon, hard carbon, soft carbon, acetylene black, carbon black, Li₄Ti₅O₁₂, anatase TiO₂, SnO, SnO₂, GeO, GeO₂, In₂O, In₂O₃, PbO, PbO₂, Pb₂O₃, Pb₃O₄, Ag₂O, Ag₂O₃, Sb₂O, Sb₂O₄, Sb₂O₅, SiO, ZnO, CoO, NiO, FeO, LiAl, LiZn, Li₃Bi, Li₃Cd, Li₃Sd, Li₄Si, Li₄₄Pb, Li₄₄Sn, Li_{0.17}C(LiC₆), Li₃FeN₂, Li₂₆CO_{0.4}N, Li₂₆Cu_{0.4}N, or any mixture thereof.

The amount of the aqueous solvent may be equal to or greater than 80 wt % of the total weight of the negative electrode composition, but is not limited thereto. The amount may vary according to those of ordinary skill in the art. For example, the amount of the aqueous solvent may be in the range of about 80 to about 95 wt % based on the total weight of the negative electrode composition.

The aqueous solvent is a solvent including water as a main component. That is, the amount of water in the aqueous solvent may be equal to or greater than 50 wt % based on the total weight of the aqueous solvent. The aqueous solvent may be a mixture of water as a main component and an auxiliary solvent as an auxiliary component. The auxiliary solvent may be water-soluble or oil-soluble. The auxiliary solvent may be a mixture of at least two solvents.

The aqueous solvent may further include alcohol auxiliary solvents such as ethanol (EtOH), methanol (MeOH), propanol (PrOH), butanol (BuOH), isopropyl alcohol (IPA), and isobutyl alcohol in addition to water to control drying rate of the solvent.

In addition, the aqueous solvent may further include auxiliary solvents such as dimethylacetamide (DMAC), dimethylformamide (DMF), dimethyl sulfoxide (DMSO), acetone, tetrahydrofuran (THF), methyl ethyl ketone (MEK), triethylphosphate, trimethylphosphate in order to increase contact angles with respect to a nozzle surface and/or a nozzle plate during the inkjet printing and with respect to the nozzle surface and/or an aluminum substrate after the inkjet printing and increase the drying rate so as to improve accuracy and resolution of patterns.

In addition, the aqueous solvent may further include amide, such as dimethylacetamide (DMAC) or dimethylformamide (DMF).

For example, the auxiliary solvent may be saturated hydrocarbon; aromatic hydrocarbon such as toluene and xylene; alcohol such as methanol (MeOH), ethanol (EtOH), propanol (PrOH), and butanol (BuOH); ketone such as acetone, methyl ethyl ketone (MEK), methyl isobutyl ketone (MIBK), and diisobutyl ketone; ester such as ethyl acetate and butyl acetate; ether such as tetrahydrofuran (THF), dioxane, and diethyl ether; dimethyl sulfoxide (DMSO) or any mixture thereof.

The amount of the dispersant may be in the range of about 0.01 to about 10 parts by weight based on 100 parts by weight of the beta phase TiO₂ particles, but is not limited thereto. The amount may vary according to those of ordinary skill in the art. If the amount of the dispersant is too low, dispersibility and jettability may be reduced. If the amount of the beta dispersant is too high, discharge capacity of an electrode may be reduced.

The dispersant may be any dispersant that is commonly used in the art to improve dispersibility of particles dispersed in a negative electrode composition.

For example, the dispersant may be a cationic dispersant, an anionic dispersant, a nonionic, and an amphoteric dispersant. In addition, the dispersant may be a waterborne polymer.

For example, the dispersant may be fatty acid salt, alkyldicarboxylate, alkyl ester sulfonate, alkyl sulfate, alkylnaphthalene sulfate, alkyl benzene sulfate, alkylnaphthalene sulfonate, alkyl sulfone succinate, naphthenate, alkylether carboxylate, acylate peptide, alpha-olefin sulfate, N-acylmethyl taurinate, alkyl ether sulfate, secondary alkyl ethoxy sulfate, polyoxyethylene alkyl formyl ether sulfate, alkyl monoglycol sulfate, alkyl ether phosphate ester, alkyl phosphate ester, alkyl amine salt, alkyl pyridium salt, alkyl imidazolium salt, fluorine- or silicon-acrylate copolymer, polyoxyethylene alkyl ether, polyoxyethylene sterol ether, lanoline derivatives of polyoxyethylene, polyoxyethylene/polyoxypropylene copolymer, polyoxyethyle sorbitan fatty acid ester, monoglyceride fatty acid ester, sucrose fatty acid ester, alkanolamide fatty acid, polyoxyethylene fatty acid amide, polyoxyethylenealkylamine, polyvinylalcohol, polyvinylpyridone, polyacrylamide, carboxyl group-containing water-soluble polyester, hydroxyl group-containing cellulose-based resin, acylate-based resin, butadiene-based resin, acrylate, styrene acrylate, polyester, polyamide, polyurethane, alkylbetaine, alkylamineoxide, phosphatidylcholine, polyacylate, and modified polyacrylate or any mixture thereof.

For example, the dispersant may be polyacylate, denatured polyacrylate, or an acrylate group-containing copolymer.

For example, the dispersant may be DISPER BYK 190 (BYK), DISPERS 745W (Tego Corporation), DISPERS 752W (Tego Corporation), SOLSEPERS 44000 (Pubrizol Corporation), 4450 (EFKA), and 4580 (EFKA).

The negative electrode composition may further include at least one selected from the group consisting of a conductor, a binder, and a moisturizer.

The amount of the conductor may be in the range of about 1 to about 10 parts by weight based on 100 parts by weight of the beta phase TiO₂ particles, but is not limited thereto. The amount of the conductor may vary according to those of ordinary skill in the art. If the amount of the conductor is too low, conductivity of the electrode may deteriorate. If the amount of the conductor is too high, discharge capacity of the electrode may be reduced.

The conductor may improve conductivity of the negative electrode, and any material that may be dispersed in the negative electrode composition may be used.

For example, the conductor may be graphite such as natural graphite or artificial graphite; carbon black such as acetylene black, ketjen black, channel black, furnace black, lamp black, and thermal black; a conductive fiber such as carbon fiber or metallic fiber; metal powder such as fluorinated carbon, aluminum, and nickel powder; a conductive whisker such as zinc oxide and potassium titanate; a conductive metal oxide such as titanium oxide; polyphenylene derivatives, or any mixture thereof.

The amount of the binder may be in the range of about 1 to about 10 parts by weight based on 100 parts by weight of the beta phase TiO₂ particles, but is not limited thereto. The amount of the binder may vary according to those of ordinary skill in the art. If the amount of the binder is too low, adhesive force of the negative electrode composition for a current collector may be reduced. If the amount of the binder is too high, discharge capacity of the electrode may be reduced.

The binder reinforces a binding force between the negative electrode active material and the current collector, and any material that is commonly used in the art may be used.

For example, the binder may be polyvinyl alcohol, ethylene-propylene-diene 3-membered copolymer, styrene butadiene copolymer, polyvinylidene fluoride (PVdF), polytetrafluoroethylene (PTFE), tetrafluoroethylene-hexafluoropropylene copolymer, carboxymethyl cellulose metal salt (M-CMC), polyimide, polyvinyl alcohol (PVA), or any mixture thereof. For example, the binder may be sodium salt of carboxymethyl cellulose or styrene-butadiene copolymer.

The amount of the moisturizer may be equal to or less than 20 wt % of the total weight of the negative electrode composition, but is not limited thereto. The amount of the moisturizer may vary according to those of ordinary skill in the art.

For example, the moisturizer may be polyhydric alcohol, such as C2-C6 polyhydric alcohol having 2 to 3 alcoholic hydroxyl groups, di or tri C2-C3 alkylene glycol, poly C2-C3 alkylene glycol having a molecular weight of 20,000 or less and having at least 4 repeating units, liquid phase polyalkylene glycol, or any mixture thereof.

For example, the moisturizer may be polyhydric alcohol such as ethylene glycol (EG), diethylene glycol (DEG), triethylene glycol (TEG), propylene glycol (PG), polyethylene glycol (PEG), polypropylene glycol, glycerin, trimethyolpropane, 1,3-pentanediol, 1,5-pentanediol, or any mixture thereof.

The negative electrode composition may have a viscosity of equal to or less than 100 cps at 25° C. at a shear rate of 1/1000 s⁻¹. For example, the viscosity may be in the range of about 0.1 to about 100 cps. If the viscosity is greater than 100 cps, the negative electrode composition may not be smoothly ejected via a nozzle. If the viscosity is less than 0.1 cps, flow rate may not be controlled.

The negative electrode composition may further include a buffer in order to maintain stability and appropriate pH of the negative electrode composition. Any buffer that is commonly used in the art may be used without limitation.

For example, the buffer may be amine such as trimethyl amine, triethyanol amide, diethanol amine, and ethanol amine; sodium hydroxide; ammonium hydroxide; or any mixture thereof.

The amount of the buffer may be in the range of about 0.1 to about 10 wt % based on the total weight of the negative electrode composition, but is not limited thereto. For example, the amount of the buffer may be in the range of about 0.1 to about 5 wt % based on the total weight of the negative electrode composition.

The negative electrode composition may further include a lithium salt in order to improve ionic conductivity of the negative electrode composition. Any lithium salt that is commonly used in the art may be used without limitation. For example, the lithium salt may be LiPF₆, LiBF₄, LiClO₄, LiAsF₆, LiTaF₆, LiAlCl₄, Li₂B₁₀Cl₁₀, or the like. The amount of the lithium salt may be in the range of about 0.01 to about 10 M, but is not limited thereto.

The negative electrode composition for inkjet print may be prepared by adding the beta phase TiO₂ particles, the dispersant, the conductor, the binder, the moisturizer, and the buffer to the aqueous solvent, dispersing the components using a ball mill or bead mill, and filtering the composition with a filter.

A negative electrode according to another embodiment of the present invention may be prepared by inkjet printing the negative electrode composition. Inkjet printing is a method of ejecting droplets of an electrode composition onto a current collector via a nozzle of an inkjet printer. The inkjet printing is classified into a thermal inkjet method and a piezoelectric inkjet method. A piezoelectric inkjet method may be used to maintain thermal stability of materials used to form a battery. The negative electrode composition including beta phase TiO₂ particles are printed on a current collector by an inkjet printing method and dried to prepare a negative electrode.

The inkjet printing of the negative electrode composition is not limited. For example, the negative electrode composition may be printed on the current collector by connecting an inkjet printer including an inkjet head to a commercially available computer and using a specialized software. The electrode ink printed on the current collector may be dried at a temperature ranging from about 20 to about 200° C. at a vacuum atmosphere for about 1 to about 8 minutes, but the method is not limited thereto. Any known material may be used to form the current collector. For example, aluminum thin film, stainless steel thin film, copper thin film, nickel thin film, or the like may be used.

A lithium battery according to another embodiment of the present invention includes a negative electrode prepared by inkjet printing the negative electrode composition. The lithium battery may have a stack structure, but the structure is not limited thereto. The lithium battery may be a lithium primary battery, a lithium secondary battery. The lithium secondary battery may be a lithium-ion battery, a lithium-polymer battery, or the like.

A method of preparing the lithium battery is not limited to the methods discussed above, as long as the lithium battery includes the negative electrode prepared by inkjet printing the negative electrode composition.

For example, the negative electrode may be prepared by inkjet printing the negative electrode composition according to an embodiment of the present invention on a current collector and drying the negative electrode composition. A positive electrode may be prepared by inkjet printing a positive electrode composition on a surface of the current collector which is opposite to the surface on which the negative electrode is formed and drying the positive electrode composition. As a result, a bipolar electrode may be prepared.

Alternatively, a monopolar electrode may be prepared by forming the positive electrode or the negative electrode on one surface of the current collector.

The positive electrode composition used to prepare the positive electrode may have the same composition as the negative electrode composition, except that the positive electrode composition includes a positive electrode active material. The positive electrode may be prepared in the same manner as the negative electrode.

Any positive electrode active material that is commonly used in the art may be used without limitation.

For example, the positive electrode active material may be Li—Co oxide such as LiCoO₂; Li—Ni oxide such as LiNiO₂; Li—Mn oxide such as spinel LiMnO₂ and LiMn₂O₄; Li—Cr oxide such as LiCr₂O₇ and LiCrO₄; Li—Fe oxide such as LiFeO₂; Li—V oxide such as LiₓV_{y}O_{z}; a compound in which transition metal is partially substituted with other elements such as LiNiₓCO₁₋ₓO₂ (0<x<1); lithium-transition metal phosphate such as LiFePO₄; transition metal such as V₂O₅, MnO₂, TiS₂, MoS₂, and MoO₃; or PbO2, AgO, or NiOOH.

An electrolyte layer having a predetermined thickness may be disposed between the bipolar electrodes or monopolar electrodes. The bipolar electrodes including the electrolyte layer may be stacked in an inert atmosphere to prepare a battery stack. The battery stack may be packed by an insulating sealing layer formed on the battery stack to prepare a lithium battery.

The electrolyte layer may be a polymer gel electrolyte layer and a separator impregnated with an electrolytic solution, but the electrolyte layer is not limited thereto.

The polymer gel electrolyte may be prepared by adding an electrolytic solution commonly used for a lithium-ion secondary battery to an ionic conductive polymer, i.e., solid polymer electrolyte, or by impregnating a polymer backbone not having ionic conductivity with the electrolyte. Alternatively, the polymer gel electrolyte may be prepared by mixing a monomer of the polymer with the electrolytic solution and polymerizing the monomer. The polymer gel electrolyte may be referred to as a polymer solid electrolyte as the degree of cross-linking of the polymer increases.

Any polymer and polymer matrix that are commonly used in the art for the polymer gel electrolyte may be used without limitation.

For example, the polymer of the polymer gel electrolyte may be polyethylene oxide, polypropylene oxide, polyethylene glycol, poly acrylonitrile, poly(vinylidene fluoride), polyvinyl chloride, poly(vinylidene fluoride-hexafluoropropylene (PVdF-H FP), polymethylmethacrylate (PMMA), or copolymers thereof.

The electrolytic solution contained in the polymer gel electrolyte may be any electrolytic solution that is commonly used in the art.

For example, the electrolytic solution used in the lithium battery is prepared by dissolving a lithium salt in a solvent. The solvent may be selected from the group consisting of propylene carbonate, ethylene carbonate, fluoroethylene carbonate, diethyl carbonate, methylethyl carbonate, methylpropyl carbonate, butylene carbonate, benzonitrile, acetonitrile, tetrahydrofuran, 2-methyltetrahydrofuran, γ-butyrolactone, dioxorane, 4-methyldioxorane, N,N-dimethyl formamide, dimethyl acetamide, dimethylsulfoxide, dioxane, 1,2-dimethoxyethane, sulforane, dichloroethane, chlorobenzene, nitrobenzene, dimethyl carbonate, methylisopropyl carbonate, ethylpropyl carbonate, dipropyl carbonate, dibutyl carbonate, diethylene glycol, dimethyl ether, and mixtures thereof. The lithium salt may be LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) where x and y are each independently a natural number, LiCl, LiI, or mixtures thereof.

In the polymer gel electrolyte, the weight ratio between the matrix polymer and the electrolytic solution may be in the range of about 1:99 to about 90:10.

The separator impregnated in the electrolytic solution may be any electrolyte layer that is commonly used in lithium-ion batteries.

The electrolytic solution used to impregnate the separator is the same as an electrolytic solution used for the polymer gel electrolyte.

The separator may be any separator that is commonly used in lithium batteries. The separator may have low resistance to migration of ions in an electrolyte and have an excellent electrolyte-retaining ability. Examples of the separator may include glass fiber, polyester, Teflon, polyethylene, polypropylene, polytetrafluoroethylene (PTFE), a combination thereof, and a material which may be in non-woven or woven fabric form. In particular, a windable separator including polyethylene, polypropylene or the like may be used for a lithium-ion battery. A separator that retains a large amount of an organic electrolytic solution may be used for a lithium-ion polymer battery. These separators may be manufactured using the following method.

A polymer resin, a filler, and a solvent are mixed to prepare a separator composition. The separator composition is directly coated on an electrode, and then dried to form a separator film. Alternately, the separator composition may be cast onto a separate support, dried, detached from the separate support, and finally laminated on an upper portion of the electrode, thereby forming a separator film.

Any polymer resin that is commonly used for binding electrode plates in lithium batteries may be used without limitation. Examples of the polymer resin may include a vinylidenefluoride/hexafluoropropylene copolymer, polyvinylidene fluoride (PVDF), polyacrylonitrile, polymethylmethacrylate and any mixture thereof.

The separator is interposed between the positive electrode and the negative electrode to form a battery assembly. The battery assembly is wound or folded and then sealed in a cylindrical or rectangular battery case. Then, the organic electrolyte solution described above is injected into the battery case to complete the manufacture of a lithium-ion battery.

Alternatively, the battery assembly is stacked in a bi-cell structure and impregnated with the organic electrolyte solution. The resultant is put into a pouch and sealed, thereby completing the manufacture of a lithium-ion polymer battery.

Hereinafter, one or more embodiments of the present invention will be described in more detail with reference to the following examples. However, these examples are not intended to limit the scope of the one or more embodiments of the present invention.

### Preparation of Beta Phase TiO₂ Particles

### Preparation Example 1

6 g of anatase TiO₂ was added to 25 ml of 10 M sodium hydroxide aqueous solution and the solution was stirred and added to a reactor equipped with a Teflon liner (40 ml). The reactor was maintained at 170° C. for 72 hours, and the resultant was added to 100 ml of 0.05 M aqueous solution of hydrogen chloride to conduct ion exchange. Then, the resultant was washed and filtered several times, dried at 80° C., and heat-treated at 350° C. to prepare beta phase TiO₂ particles. As a result of observing the beta phase TiO₂ particles using a scanning electron microscope (SEM), the particle diameter was distributed within the range of about 100 to about 250 nm, and an average particle diameter was 125 nm.

### Preparation of Negative Electrode Composition

### Example 1

4.65 wt % of beta phase TiO₂ particles, 0.15 wt % of acetylene black (AB), 0.19 wt % of carboxymethyl cellulose (CMC 1205), and 0.01 wt % of denatured polyacylate dispersant (EFKA 4580) were added to a mixed solvent including 70 wt % of water, 20 wt % of ethanol (EtOH), and 5 wt % of diethylene glycol (DEG) to prepare a mixture. The mixture was added to a ball mill including zirconia beads having a particle diameter of 3 mm and dispersed for 24 hours. Then, the dispersed mixture was sequentially filtered using polytetrafluoroethylene (PTFE) syringe filters (Whatman) having pore sizes of 1 μm and 0.45 μm to prepare a negative electrode composition.

### Comparative Example 1

4.65 wt % of Li₄Ti₅O₁₂ particles, 0.15 wt % of acetylene black (AB), 0.19 wt % of carboxymethyl cellulose (CMC), and 0.01 wt % of denatured polyacylate dispersant (EFKA 4580) were added to a mixed solvent including 70 wt % of water, 20 wt % of ethanol (EtOH), and 5 wt % of diethylene glycol (DEG) to prepare a mixture. The mixture was added to a ball mill including zirconia beads having a particle diameter of 3 mm and dispersed for 24 hours. Then, the dispersed mixture was sequentially filtered using polytetrafluoroethylene (PTFE) syringe filters (Whatman) having pore sizes of 1 μm and 0.45 μm to prepare a negative electrode composition.

### Comparative Example 2

4.65 wt % of beta phase TiO₂ particles, 0.15 wt % of acetylene black (AB), and 0.2 wt % of polyvinylidene fluoride (PVdF) were added to 95 wt % of N-methylpyrrolidone to prepare a mixture. The mixture was added to a ball mill including zirconia beads having a particle diameter of 3 mm and dispersed for 24 hours. Then, the dispersed mixture was sequentially filtered using polytetrafluoroethylene (PTFE) syringe filters (Whatman) having pore sizes of 1 μm and 0.45 μm to prepare a negative electrode composition.

### Comparative Example 3

4.65 wt % of Li₄Ti₅O₁₂ particles (nGimat), 0.15 wt % of acetylene black (AB), and 0.2 wt % of carboxymethyl cellulose (CMC) were added to a mixed solvent including 70 wt % of water, 20 wt % of ethanol (EtOH), and 5 wt % of diethylene glycol (DEG) to prepare a mixture. The mixture was added to a ball mill including zirconia beads having a particle diameter of 3 mm and dispersed for 24 hours. Then, the dispersed mixture was sequentially filtered using polytetrafluoroethylene (PTFE) syringe filters (Whatman) having pore sizes of 1 μm and 0.45 μm to prepare a negative electrode composition.

Compositions and viscosities of the negative electrode compositions prepared according to Example 1 and Comparative Examples 1 through 3 are shown in Table 1 below.

TABLE 1

| | Example | Comparative | Comparative | Comparative |
|---|---|---|---|---|
| | 1 | Example 1 | Example 2 | Example 3 |
| Active material (beta phase TiO₂) | 4.65 | — | 4.65 | 4.65 |
| Active material (Li₄Ti₅O₁₂) | — | 4.65 | — | — |
| Conductor (carbon black) | 0.15 | 0.15 | 0.15 | 0.15 |
| Solvent (water) | 70 | 70 | — | 70 |
| Auxiliary solvent (ethanol) | 20 | 20 | — | 20 |
| Moisturizer (DEG) | 5 | 5 | — | 5 |
| Solvent (NMP) | — | — | 95 | — |
| Binder (CMC) | 0.19 | 0.19 | — | 0.2 |
| Binder (PVdF) | — | — | 0.2 | — |
| Dispersant (EFKA4580) | 0.01 | 0.01 | — | — |
| Viscosity [cps] | 5 | 5 | 5 | 5 |
| (25° C., 1/1000 s⁻¹) | | | | |
| Total | 100 | 100 | 100 | 100 |

In Table 1, the unit of the components is wt %.

### Preparation of Negative Electrode and Lithium Battery

### Example 2

The negative electrode compositions prepared according to Example 1 and Comparative Examples 1 to 3 were respectively printed on a copper foil using a Fuji Dimatix DMP-2800 inkjet printer to form a circular pattern (1 cm²), and the pattern was vacuum dried at 120° C. for 2 hours to prepare a negative electrode.

The negative electrode, a lithium metal constituting a counter electrode, a polypropylene layer (Cellgard 3501) constituting a separator, and an electrolyte solution obtained by dissolving 1.3 M of LiPF₆ in a mixed solvent of ethylene carbonate (EC) and diethylene carbonate (DEC) (volume ratio of 3:7) were used to manufacture a CR-2016 standard coin cell.

### Comparative Examples 4 to 6

Negative electrodes and lithium batteries were prepared in the same manner as in Example 1, except that the negative electrode compositions prepared according to the Comparative Examples 1 to 3 were used instead of the negative electrode composition prepared according to Example 1, respectively.

### Evaluation of Ink Jettability

### Evaluation Example 1

While printing a circular pattern on a copper foil using the inkjet printer according to Example 2 and Comparative Examples 4 to 6, ink jettability was evaluated from the printed circular pattern. The results were classified according to the following standards. The results are shown in Table 2 below.

∘: Ink was smoothly ejected so that a uniform circular pattern was printed.

: Ink was not smoothly ejected so that a non-uniform circular pattern was printed.

x: The ink nozzle was blocked so that ink was not ejected.

### Evaluation of Binding Force of Electrode

### Evaluation Example 2

Binding forces between the negative electrode active material layer and the current collector in the negative electrode prepared according to Example 2 and Comparative Examples 4 to 6 were classified according to the following standards. The results are shown in Table 2 below.

∘: After pressing, the negative electrode active material layer was not detached from the current collector.

: After pressing, the negative electrode active material layer was detached from the current collector.

x: After coating and drying the electrode ink, the active material layer is detached from the current collector without pressing.

### Charge-Discharge Test

### Evaluation Example 3

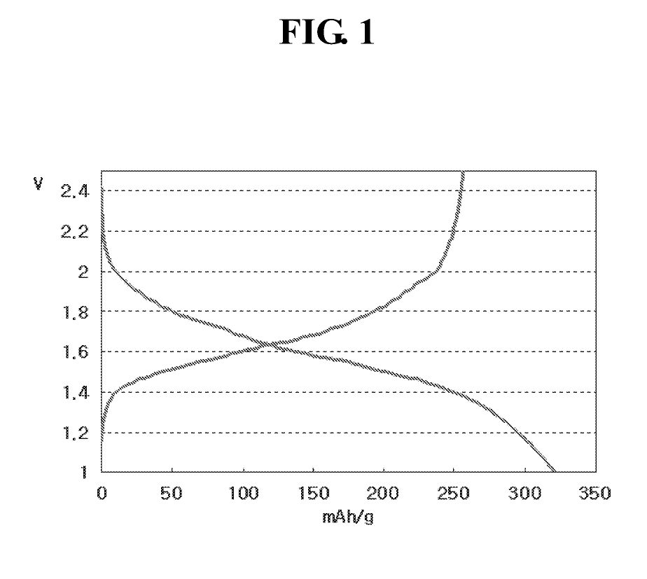

The lithium batteries manufactured according to Example 2 and Comparative Examples 4 to 6 were discharged until the voltage thereof reached 1.0 V (with respect to Li) by flowing a current of 20 mA per 1 g of the negative electrode active material, and then charged at the same flow rate of current until the voltage reached 2.5 V (with respect to Li). Then, the cycle of discharging and charging were repeated 50 times at the same flow rate of current to the same voltage. The results are shown in FIG. 1 and Table 2 below.

TABLE 2

| | | Capacity | | Binding force |
|---|---|---|---|---|
| | | retention | | between negative |
| | Discharge | rate at 50^{th} | Ink | electrode |
| | capacity | charge- | jettability | active material |
| | at 1^{st} cycle | discharge | charac- | layer and |
| | [mAh/g] | cycle [%] | teristics | current collector |
| Example 2 | 256 | 89 | ∘ | ∘ |
| Comparative | 172 | 95 | ∘ | ∘ |
| Example 4 | | | | |
| Comparative | Non- | Non- | ∘ | x |
| Example 5 | measurable | measurable | | |
| Comparative | Non- | Non- | x | Non-measurable |
| Example 6 | measurable | measurable | | |

As shown in Table 2, the lithium battery including the beta phase TiO₂ as a negative electrode active material showed higher discharge capacity than the lithium battery including a general lithium titanium oxide prepared according to Comparative Example 4. Furthermore, the lithium battery according to Example 2 had excellent lifetime characteristics. The lithium battery according to Example 2 also had excellent ink jettability and binding force with the current collector.

As described above, according to the one or more of the above embodiments of the present invention, the lithium battery including the negative electrode prepared by inkjet printing the negative electrode composition for inkjet print including the negative electrode active material may have excellent lifetime and capacity characteristics.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A negative electrode composition for inkjet print, the composition comprising:
beta phase TiO₂ particles;
an aqueous solvent; and
a dispersant.

2. The negative electrode composition of claim 1, wherein the negative electrode composition has a viscosity of equal to or less than 100 cps at 25° C. at a shear rate of 1/1000 s⁻¹.

3. The negative electrode composition of claim 1, wherein an average particle diameter of the beta phase TiO₂ particles is less than 1 μm.

4. The negative electrode composition of claim 1, wherein an amount of the beta phase TiO₂ particles is in the range of about 1 to about 10 wt % based on a total weight of the negative electrode composition.

5. The negative electrode composition of claim 1, wherein an amount of the aqueous solvent is equal to or greater than 80 wt % based on a total weight of the negative electrode composition.

6. The negative electrode composition of claim 1, wherein an amount of the dispersant is in the range of about 0.01 to about 10 parts by weight based on 100 parts by weight of the beta phase TiO₂ particles.

7. The negative electrode composition of claim 1, further comprising at least one selected from the group consisting of a conductor, a binder, and a moisturizer.

8. The negative electrode composition of claim 7, wherein an amount of the conductor is in the range of about 1 to about 10 parts by weight based on 100 parts by weight of the beta phase TiO₂ particles.

9. The negative electrode composition of claim 7, wherein an amount of the binder is in the range of about 1 to about 10 parts by weight based on 100 parts by weight of the beta phase TiO₂ particles.

10. The negative electrode composition of claim 7, wherein an amount of the moisturizer is equal to or less than 20 wt % based on a total weight of the negative electrode composition.

11. A negative electrode prepared by inkjet printing the negative electrode composition according to claim 1.

12. A lithium battery including the negative electrode of claim 11.
